(19) United States
(12) Patent Application Publication
(10) Pub. No.: US 2026/0241917 A1
(43) Pub. Date: Aug. 20, 2026

(54) ELECTRIC/HEAT HYBRID PROPULSION VEHILE WITH SPORTS MODE FOR CONTROLLING THE HEAT ENGINE AND RELATED CONTROL METHOD

(71) Applicant: LEOTECH S.R.L., Canal San Bovo (TN) (IT)

(72) Inventor: Italo CORONA, Canal San Bovo (TN) (IT)

(21) Appl. No.: 19/161,874

(22) PCT Filed: Mar. 5, 2024
(86) PCT No.: PCT/IB2024/052118

§ 371 Date: Sep. 3, 2025

(30) Foreign Application Priority Data
Mar. 6, 2023 (IT) 102023000004014

(51) Int. Cl. B60W 20/15; B60W 10/06; B60W 10/08; B60W 50/08

(52) U.S. Cl. CPC B60W 20/15; B60W 10/06; B60W 10/08; B60W 50/082; B60W 2510/0638; B60W 2510/244; B60W 2540/10

(57) ABSTRACT

A series hybrid propulsion wheeled vehicle includes at least an electric motor mechanically connected to one or more drive wheels of the vehicle, a heat engine exclusively dedicated to the production of electric energy by means of an electric power generator connected thereto, a storage battery, an accelerator pedal and a control unit which operates, adjusts, and controls the vehicle components. The vehicle also includes a gearbox simulator and a driving mode selector. In a sports driving mode preselected in the driving mode selector, the control unit directly connects a fuel supply of the heat engine to the accelerator pedal and controls the rotation speed of the electric motor to obtain speed and acceleration performances of the vehicle corresponding to the actual rpm of the heat engine and to the gear level selected on the gearbox simulator. The application also includes a control method of the vehicle.

### FIELD OF INVENTION

The present invention relates to a hybrid propulsion vehicle comprising an electric motor and a heat engine, and in particular to a so-called series hybrid vehicle, i.e., a vehicle wherein only the electric motor is mechanically connected to the drive wheels while the heat engine is exclusively dedicated to producing electric power by means of a special electric power generator, for direct consumption by the electric motor or for battery recharging. The invention also relates to a control method of such a vehicle.

### BACKGROUND OF THE PRIOR ART

In highly industrialized countries, including in particular the United States of America and the European Union, there has been a strong boost in recent years, especially in the political circles, towards an electric conversion of circulating vehicles. In particular, in the European Union it is currently expected that sales of vehicles exclusively equipped with heat engines will cease from 2035.

Although electric vehicles offer nowadays performances which are practically comparable, in terms of maximum speed, and averagely superior, in terms of pick-up, to heat engines, a substantial part of consumers are still strongly resistant to the idea of using an electric vehicle.

Among the reasons for such resistance also exists—in addition to more strictly technical reasons such as low autonomy, limited network of electric energy distributors and excessively long duration of battery recharging operations—the absence of the traditional variable roar of the heat engine which represents, at least for that part of consumers who love sporty driving, a sensorial experience of driving which cannot be given up.

Furthermore, since the noise emitted by electric vehicles moving at low speed in residential areas—essentially caused by the friction between the wheels and the road surface—is extremely low, unexpected hazardous situations can easily occur when maybe temporarily distracted pedestrians do not notice the advancement of an electric vehicle by its noise, therefore risking being hit by the same or in any case being unprepared for its arrival.

The just exposed problem, i.e., that of an essentially “voiceless” electric motor at urban speeds, has been solved by equipping electric vehicles with a digital noise (e.g. recorded or synthesized) coming from an apparatus mounted on the vehicle, for example an integrated loudspeaker, both inside, i.e., in the passenger compartment, and outside of said vehicle. The internal loudspeaker is used to artificially reproduce the typical sound of a heat engine in the passenger compartment, thus giving again to the driver the pleasure feeling that this sound can generate, while the one or more external loudspeakers simply reproduce a constant sound having a frequency suitable for being easily perceived, exclusively intended for prevention of road accidents with pedestrians crossing the road.

As regards the reproduction of the sound of a heat engine inside the passenger compartment of an electric vehicle, the known art has been addressed to improving the quality and position of the loudspeakers, as well as the type of reproduced sounds, to obtain a perfected acoustic reproduction in the passenger compartment, to induce in the driver the feeling of actually perceiving the authentic sound of a heat engine.

However, these attempts are far from having achieved a fully satisfactory result, first because the human ear is refined enough to be able to distinguish an artificially reproduced sound from the authentic sonority of a moving heat engine, especially considering that such listening occurs, for the majority of drivers, in a daily repetitive manner and is therefore inevitably subject to particularly careful and critical analysis.

However, another important reason why the artificially reproduced sound of a heat engine is unsatisfactory for the user is that when driving a vehicle equipped with a real heat engine, the driver can perceive, in addition to the sound, also the vibrations directly imparted to the driver's body by the heat engine through the chassis and the seat, or other particular sound and dynamic stimuli caused by the ordinary operation of a heat engine which requires the use of clutch and gearbox. While using the clutch and gear shifting, in fact, a momentary drop of acceleration (or deceleration if downshifting) is experienced, followed by an acceleration (or deceleration) pick-up when the new gear has been engaged and the clutch released. Meanwhile, the heat engine sound is minimized during gear shifting, and then gradually starts to rise again when accelerating, or sharply rises to maximum rpm when decelerating using engine braking.

With a system of loudspeakers, no matter how accurate it may be, it is impossible to realistically reproduce these sounds. It is therefore inevitable that that part of consumers who are most fond of the sports driving of traditional heat engine cars remains alienated and unsatisfied with the synthetic or simulated sounds offered by the market so far. There is therefore a strongly felt need for an electric propulsion system which is capable of simulating in a more realistic way a traditional heat engine sound and the other sound and dynamic stimuli that a driver is used to perceiving in the different driving phases of a traditional heat engine vehicle.

EP-4023475 (2022) addressed the problem reported above by proposing a series hybrid vehicle wherein an acceleration command given by the user simultaneously controls the electric motor and the torque of the heat engine, to synchronize the latter to the speed expressed by the electric motor.

However, the sound effect obtained from this technical solution is not completely satisfactory, since the user has direct control only of the electric motor and therefore the heat engine rpm and their gradual activation are determined only indirectly, by controlling the torque of the heat engine. The resulting sound is therefore penalized, dampened, and delayed; it is therefore not possible, for example, to make a free acceleration of the heat engine, with the car stationary or when gear shifting, just as it is not possible to bring the heat engine into over-revving mode since, as is known, the torque of the heat engine at very high rpm is less than the maximum torque.

EP-2426022 and US-2020/0391742 concern other methods of automatic control of the heat engine of a series hybrid vehicle to optimize its operation.

### Problem and Solution

The technical problem underlying the invention is therefore to provide an electric propulsion vehicle which overcomes the inherent limitations in the known art illustrated above and which therefore allows the driver to perceive exactly the same sound and dynamic stimuli which are normally perceived while driving a traditional sports vehicle with heat engine.

Within the ambit of this technical problem, a first object of the present invention is to reproduce the typical sound of a variable speed heat engine in an electric propulsion vehicle, during starting, acceleration and deceleration steps.

A second object of the present invention is to reproduce in an electric propulsion vehicle the momentary drop of the acceleration or deceleration of the vehicle which is typical of the gear shifting step of a traditional heat engine vehicle, or the free acceleration when the gearbox is in neutral position (i.e., not in gear).

Finally, a third object of the present invention is to reproduce in an electric propulsion vehicle the typical sound of a heat engine with variable rpm, during gear upshifting (acceleration) and downshifting (engine braking or pick-up).

These objects are achieved by means of a hybrid propulsion vehicle comprising an electric motor and a heat engine having the features defined in claim 1 and by a control method of said vehicle, having the features defined in claim 12. The secondary claims define additional features of the invention.

### BRIEF DESCRIPTION OF THE DRAWINGS

Further features and advantages of the hybrid propulsion vehicle of the invention will anyhow become more evident from the following detailed description of a preferred embodiment of the same, given by mere way of non-limiting example and illustrated in the accompanying drawings, wherein:

FIG. 1 is a schematic side view illustrating the functional elements of a hybrid propulsion vehicle according to the present invention; and

FIG. 2 is a plan view of the hybrid propulsion vehicle of FIG. 1.

### DETAILED DESCRIPTION OF THE PREFERRED EMBODIMENT

While driving a vehicle provided with a traditional heat engine and gearbox, no matter whether a manual, semi-automatic or automatic gearbox, the driver is continuously exposed to a succession of different sound, visual and dynamic stimuli, while carrying out the following different driving operations, which mainly interfere with the senses of hearing, sight, touch and balance (this latter essentially consisting of the inner ear vestibular apparatus, which is capable of perceiving accelerations and decelerations).

Some typical driving operations of a heat engine vehicle will now be listed, describing the corresponding stimuli perceived by the driver:
1. heat engine start
   a. hearing—the typical noise of the starter motor, the initial ignition roar of the heat engine and finally the subsequent rpm settling at “minimum” rpm;
   b. touch—the running heat engine vibrations are perceived;
2. vehicle acceleration
   a. hearing—a growing heat engine sound, which becomes increasingly shriller as the rpm increase, until reaching a maximum “plateau” value;
   b. balance—strong initial acceleration is perceived, which then gradually decreases as the rpm increase;
   c. touch—acceleration and its variations are also perceived by the reaction pressure exerted by the seat backrest on the driver's back;
   d. sight—increase in speed/engine rpm is perceived by seeing the position indicators moving from low to high values.
3. gear shifting (upshifting)
   a. hearing—heat engine sound reduction to “minimum” rpm, and resumption of an increasing sound following gear upshifting;
   b. balance—perception of temporary pause of acceleration, followed by a new acceleration upon gear upshifting;
   c. touch—temporary reduction of the pressure on the driver's back by the seat backrest during the gear shifting, and new increase following gear upshifting;
   d. sight—speed indicator stasis and rpm reduction to “minimum” during the shift, followed by rpm indicator rise from a lower level than that before the shifting;
4. gear shifting (downshifting—engine braking)
   a. hearing—heat engine sound quick increase due to a gear downshifting and to the consequent increase in engine rpm;
   b. balance—perception of a sudden and progressive deceleration alternating with temporary pauses of deceleration, when downshifting the gear even more;
   c. touch—reduction of pressure on the driver's back during engine braking, increase in pressure on driver's hands resting on the steering wheel;
   d. sight—sudden rise of the rpm indicator when gear downshifting, followed by slow descent of the speed indicator and of the rpm indicator during the engine braking action;
5. gear shifting (downshifting—pick-up)
   a. hearing—heat engine sound rapid increase due to a gear downshifting and to the consequent rpm increase;
   b. balance—perception of rapid and progressive acceleration;
   c. touch—increased pressure on the driver's back during pick-up;
   d. sight—sudden rise in the rpm indicator when downshifting, followed by speed indicator and rpm indicator rise during pick-up;
6. braking
   a. hearing—heat engine sound rapid reduction to “minimum” rpm;
   b. balance—perception of progressive deceleration, the stronger the more intense the braking action is;
   c. touch—reduced pressure on the driver's back and increased pressure on the driver's hands resting on the steering wheel;
   d. sight—reduction of the rpm to “idle” and gradual descent in the speed indicator.

On the contrary, while driving an electric vehicle, the driver experiences only a part of the sound, dynamic and visual stimuli described above, during the various operations connected to driving. In particular, are lost: all the stimuli related to hearing, since the electric motor has essentially no significant noise emissions; all the balance, touch and visual stimuli connected to gear shifting operations, considering that the electric motor has a continuously variable operation from low to high speeds and vice versa; and finally also the visual stimuli related to the different indications of the speed indicator and the rpm indicator, which in an electric motor are in fact coincident. This loss of sensory stimulations, which in urban and motorway driving is normally perceived as a positive element of stress reduction, causes instead a significant reduction in driving pleasure during a vehicle sports driving. On the other hand, the complexity and the different interrelationships existing between such stimuli make the same completely unrepeatable by a loudspeaker system, however complex and accurate it may be, since in this way there is no coherent correlation between the thus artificially reproduced heat engine sound and the other sensory stimuli received by the senses of balance, touch and sight during the operation of a real heat engine, which stimuli are largely missing in an electric propulsion vehicle. In the technical solution proposed by EP-4023475, a certain correlation is obtained between the heat engine sound and the other stimuli produced by the car dynamics; however, for the reason already mentioned above, this heat engine sound is to a large extent dampened and delayed due to the fact that the heat engine is indirectly controlled, by means of the electric motor; the user therefore has the feeling of no longer having the direct control of the heat engine he is used to. It is therefore a technical solution more suitable for non-sports driving, wherein the heat engine sound is not as relevant as in sports driving.

According to a brilliant insight of the inventor, the above-mentioned technical problem can be solved by means of a series hybrid propulsion vehicle, i.e., a vehicle comprising an electric motor mechanically connected to the drive wheels and a heat engine exclusively dedicated to the production of electric energy by means of an electric power generator, wherein a sports mode of control of the heat engine is provided. In such sports mode, rather than being operated at the constant speed of greatest efficiency or controlled in torque, as occurs in the cited prior art, the fuel supply of the heat engine is directly connected to the accelerator pedal operated by the user and to an electronic gearbox simulator, controlled by the driver in a traditional way, while the rotation speed of the electric motor is controlled by an electronic control system, in order to obtain mechanical performances of the vehicle, in terms of speed and acceleration, which proportionally correspond, to the actual rpm of the heat engine and to the gear level selected on the gearbox simulator, including the variations in speed and acceleration connected to gear shifting, engine braking and pick-up operations. In the case of strong acceleration not supported by the electric current production of said electric power generator, an additional power supply from said battery is let in. Therefore, contrary to what disclosed by EP-4023475, the user maintains direct control of the heat engine operation, and the reproduction of the driving perceptions remains therefore completely unaltered for the driver, compared to a traditional thermal propulsion vehicle, despite the vehicle being an entirely electric propulsion vehicle. A coefficient of proportionality between the heat engine 2 operation and the gearbox simulator 11 position on the one hand, and the electric motor 7 operation on the other hand, is then preferably selectable from several different values, so that the driver can choose between driving mode with lower or higher heat engine rpm on average, the electric motor performance being the same. Obviously, the above-described sports driving mode can be interrupted at any time, both for travelling in low-pollution areas such as city centres, and to reduce or eliminate the heat engine noise, bringing it back to constant speed conditions or completely turning it off to have a vehicle with no emissions and fully electric propulsion supported by a battery.

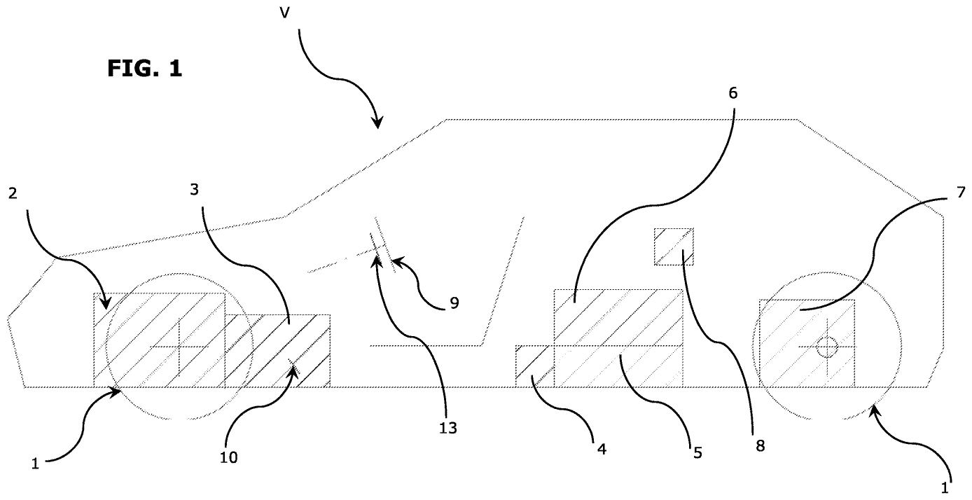

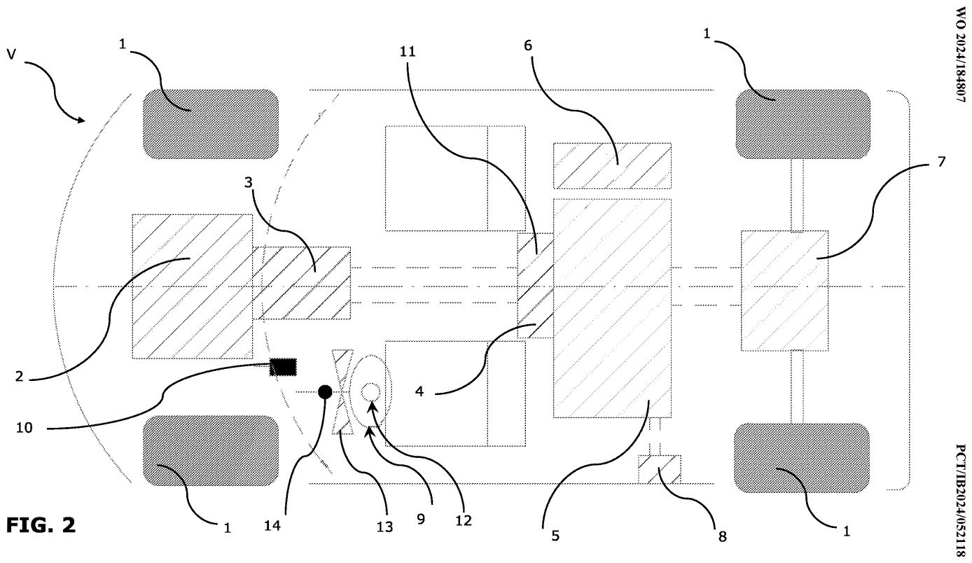

FIGS. 1, 2 schematically illustrate an electric/thermal series hybrid propulsion four-wheel vehicle V on which the sports driving mode according to the present invention is installed. In a per se known manner, the vehicle V includes a heat engine 2, an electric power generator 3 mechanically coupled to the heat engine 2, a control unit 4 with attached inverter, a battery 5, a fuel tank 6 for the heat engine 2, one or more electric motors 7 mechanically connected to the wheels 1 of the vehicle V, which in certain circumstances can act as electric power generators to recharge the battery 5, an electrical socket 8 to connect the battery 5 to external recharging sources, a steering wheel 9 and an accelerator pedal 10.

The sports driving mode according to the present invention, which allows to perfectly simulate the driving of a traditional thermal propulsion vehicle, provides, in addition to the known elements described above, a gearbox simulator 11 associated with the control unit 4, a driving mode selector 12 incorporated in the steering wheel 9, one or more levers 13 for operating the gearbox simulator 11, positioned on the steering column of the steering wheel 9 or on the steering wheel 9 itself, i.e., in a convenient position for being operated by the driver without moving driver's hands from the steering wheel 9, and finally a start/stop button 14 by which the heat engine can be started in sports driving mode.

On the above-described vehicle V are present all the mechanical connections and/or electrical/electronic couplings which are per se well known in series hybrid propulsion vehicles, such as in particular those between the control unit 4, the battery 5 and the electric motor 7, on one side, and between the control unit 4, the electric power generator 3 and the heat engine 2, on the other side. These known couplings allow the vehicle to move in two different modes: a first completely electric mode—used for example within urban areas with limited circulation, or when starting from standstill—wherein the electric motor 7 is exclusively driven by the battery 5, with a route autonomy which is therefore limited by the battery 5 capacity, and a second hybrid mode wherein the heat engine 2 is automatically started as soon as the battery 5 charge drops below a pre-established threshold and is maintained at constant rpm of maximum efficiency to directly power the electric motor 7 and/or to keep the battery 5 in a fully charged condition. In both these driving modes, the accelerator pedal 10 adjusts the electric motor 7 rpm through the control unit 4, allowing the vehicle to move from standstill up to maximum speed without need for a mechanical gearbox. In the event of slowdowns or braking, the electric motor 7 acts in turn as an electric power generator, so helping to recharge the battery 5.

According to the present invention, in addition to these two known driving modes, a further sports driving mode is provided, by means of the driving mode selector 12 positioned on the steering wheel 5. The activation of the sports driving mode causes the deactivation of the heat engine 2 automatic control and enables its manual control by means of a traditional mechanical or digital start/stop button 14 for manual starting of the heat engine, an accelerator pedal 10, a gearbox simulator 11 and relative operating levers 13, for example a right lever for gear upshifting and a left lever for gear downshifting, under the general control of the control unit 4.

Once the heat engine 2 is started using the start/stop button 14, it is possible to use the gearbox simulator 11 to first select the driving direction (forwards or backwards). Thereafter, a press on the accelerator pedal 10 will cause, through the control unit 4, the direct acceleration of the heat engine 2 over the entire admissible rpm range for the same (for example 1500-8000 rpm). The acceleration mode is determined by the control unit 4, in accordance with the gear selected from time to time on the gearbox simulator 11, by means of the right lever 13, and with the current speed imparted by the electric motor 7 to the vehicle V. The transmission of movement to the wheels 1, in fact, is still carried out directly by the electric motor 7, but said electric motor is no longer directly controlled by the accelerator pedal 10, but instead by the control unit 4 which adjusts the speed and acceleration of the electric motor 7 as a function of the rpm of the heat engine 2 and of the gear selected on the gearbox simulator 11, which are both set by the driver, to obtain a behaviour of the vehicle V consistent with that of a traditional thermal propulsion vehicle, thus giving the driver a real feeling of perfect synchronism between rpm variations in heat engine 2 and vehicle speed.

Therefore, when the sports mode is selected on the driving mode selector 12, starting the vehicle from standstill requires starting the heat engine through the start/stop button 14, while the parking position (i.e., not in gear and with handbrake activated) is selected. With the heat engine running, it is possible to freely accelerate, with the car in stationary condition, to check whether the heat engine sound is regular, and then engage first gear on the gearbox simulator 11, using the right lever 13. The vehicle thus starts, as soon as the accelerator pedal 10 is pressed, and such gear allows an increase in speed proportional to the increase in the heat engine (2) rpm up to a value determined by the driver beyond which he/she can operate one of the levers 13 (the one on the right, for upshifting) selecting a higher gear on the gearbox simulator 11 and thus allowing a corresponding reduction in the heat engine rpm and a consequent increased vehicle speed. This operation is then repeated, just like in a traditional heat engine car, until the maximum speed of the vehicle is reached when the highest gear is selected on the gearbox simulator 11. The gear shifting operations, both up and down, are carried out manually using one of the two right or left levers 13; a totally automatic option of gear shifting by the gearbox simulator 11 is also provided, with the gear upshifting or downshifting being automatically activated every time the heat engine 2 rpm exceed/drop below respectively maximum and minimum predetermined rpm threshold values. If the vehicle stops, the driver presses the start/stop button 14, the heat engine shuts off and the gearbox simulator 11 is automatically positioned on parking mode.

The control unit 4 acts therefore both in a first direction, i.e., to adjust the electric motor 7 rotation according to the rpm imposed by the driver on the heat engine 2 by means of the accelerator 10 and depending on the gear level selected on the gearbox simulator 11, and in an opposite direction, i.e., to limit the heat engine 2 acceleration depending on the actual acceleration possibilities of the electric motor so as to perfectly simulate the operation of a heat engine which is directly subjected to the load of the vehicle traction. This bidirectional control of the control unit 4 thus also occurs during gear shifting operations on the gearbox simulator 11, during which the rotation speed of the heat engine decreases and, in parallel, the electric motor 7 acceleration is reduced or zeroed, thus perfectly simulating gear shifting operations too, both upshifting, and downshifting in the two different modes of engine braking and pick-up. Similarly to what happens in the use of a heat engine vehicle with mechanical gearbox, in the sports driving mode of a series hybrid propulsion vehicle according to the present invention it thus occurs that in each gear of the gearbox simulator 11 a plateau condition of the heat engine 2 is reached in a longer time than the previous gear. This is precisely due to the bidirectional control of the control unit 4 described above which, in fact, takes into account the time it actually takes the electric motor 7 to develop a corresponding maximum speed at each gear of the gearbox simulator 11, at the same time limiting the rpm increase in the heat engine 2 within values corresponding to the actually gradually developed speeds, according to a selectable proportionality coefficient, as already described above. Finally, when the gearbox simulator 11 is in the neutral position (not in gear), the control unit 4 does not make any intervention and the free acceleration of the heat engine is exclusively controlled by the user's action on the accelerator pedal 10.

The present invention consists therefore in having added, among the different driving modes provided for a series hybrid propulsion vehicle, a new sports driving mode, completely new in its operation, which allows to recover the driving pleasure well known in traditional thermal propulsion vehicles also in a series hybrid propulsion vehicle, i.e., a vehicle which includes a heat engine on-board, thus fully achieving all the objects of the present invention. Thus, the sports driving mode according to the present invention allows to use in series hybrid vehicles even sophisticated heat engines with high performance, so as to offer the vehicle owner not only the pleasant sight of a jewel of high mechanical and advanced design, but also all the usual auditive and dynamic stimuli caused by such heat engine which are essential for the pleasure of sports driving, whenever desired and whenever such high performance can be exploited.

The high degree of sophistication of the electronic control—by means of the control unit 4—both of the heat engine 2 coupled to the electric power generator 3 and of the traction electric motor 7 in its dual function of traction motor and of electric power generator in the event of slowing down or braking of the vehicle, allows to fully exploit the high performance of the electric motors thus also obtaining maximum energy efficiency of the vehicle without giving up the pleasure—obviously on occasions wherein the route features allows it—of a sound of the heat engine 2 actually comparable to that of a sports vehicle solely equipped with a heat engine of similar features. The heat engine 2 can also advantageously be of the ecological bi-fuel type, i.e., using fuels such as HVO or similar fuels, thus contributing to reducing emissions into the environment.

However, it is understood that the invention should not be considered as limited to the specific arrangement illustrated above, which is only an exemplary embodiment thereof, but that different variants are possible, all within the reach of a person skilled in the art, without thereby departing from the scope of protection of the invention itself, as defined by the following claims.

For example, although the present invention has been described and illustrated in its application to a four-wheeled vehicle, it may be identically applicable to a vehicle with two or more wheels.

1) Series hybrid propulsion wheeled vehicle, comprising at least an electric motor (7) mechanically connected to one or more drive wheels (1) of said vehicle, a heat engine (2) exclusively dedicated to the production of electric energy by means of an electric power generator (3) connected thereto, a storage battery (5), an accelerator pedal (10) and a control unit (4) which operates, adjusts, and controls said components of the vehicle, further including a gearbox simulator (11) and a driving mode selector (12), wherein, in a sports driving mode preselected in said driving mode selector (12), said control unit (4) directly connects a fuel supply of said heat engine (2) to the accelerator pedal (10) and controls the rotation speed of said electric motor (7) in order to obtain speed and acceleration performances of said vehicle which correspond to the heat engine (2) actual rpm and to the gear level selected on said gearbox simulator (11).

2) Series hybrid propulsion wheeled vehicle according to claim 1, wherein said control unit (4) furthermore limits the increase of rpm of said heat engine (2) within values corresponding to the progressive speeds actually developed by the vehicle under the impulse of said electric motor (7).

3) Series hybrid propulsion wheeled vehicle according to claim 2, further comprising a mechanical or digital start/stop button (14) to start and stop said heat engine (2) in said sports driving mode.

4) Series hybrid propulsion wheeled vehicle according to claim 3, wherein said gearbox simulator (11) has a manual selection and said vehicle also includes levers (13) for operating the gearbox simulator (11), located close to a steering wheel (5) of said vehicle.

5) Series hybrid propulsion wheeled vehicle according to claim 3, wherein said gearbox simulator (11) has an automatic selection, based on the rotation speed of said heat engine (2).

6) Series hybrid propulsion wheeled vehicle according to claim 3, wherein a coefficient of proportionality between the heat engine (2) operation and the gear level selected on the gearbox simulator (11) on the one hand, and the electric motor (7) operation on the other hand, is selectable from several different values.

7) Series hybrid propulsion wheeled vehicle according to claim 3, wherein said speed and acceleration performances also include both the effects of engine braking, with battery (5) recharging by the electric motor (7), and of pick-up following a gear downshifting operation on the gearbox simulator (11).

8) Series hybrid propulsion wheeled vehicle according to claim 4, wherein said speed and acceleration performances also include the effect of temporary pause of acceleration or deceleration consequent to a gear upshifting or downshifting operation, respectively, on the gearbox simulator (11).

9) Series hybrid propulsion wheeled vehicle according to claim 4, wherein said speed and acceleration performances also include a free acceleration of the heat engine, directly controlled by the driver by means of said accelerator pedal (10), when the gearbox simulator (11) is in neutral position.

10) Series hybrid propulsion wheeled vehicle according to claim 1, wherein said driving mode selector (12) is positioned close to a steering wheel (5) of said vehicle.

11) Series hybrid propulsion wheeled vehicle according to claim 1, wherein said driving mode selector (12) includes an electric driving mode, wherein said control unit (4) directly connects an electric power supply of said electric motor (7) to the accelerator pedal (10) and said heat engine (2) is not operated.

12) Series hybrid propulsion wheeled vehicle according to claim 1, wherein said driving mode selector (12) includes a hybrid driving mode, wherein said control unit (4) directly connects an electric power supply of said electric motor (7) to the accelerator pedal (10) and said heat engine (2) is operated at a constant speed corresponding to its most efficient condition, depending on the battery (5) charge status.

13) Control method of a series hybrid propulsion wheeled vehicle, comprising at least an electric motor (7) mechanically connected to one or more drive wheels (1) of said vehicle, a heat engine (2) exclusively dedicated to the production of electric energy by means of an electric power generator (3) connected thereto, a storage battery (5), an accelerator pedal (10), a gearbox simulator (11) and a driving mode selector (12), and a control unit (4) which operates, adjusts, and controls said components of the vehicle wherein, in a sports driving mode preselected in said driving mode selector (12), said control unit (4) directly connects a fuel supply of said heat engine (2) to the accelerator pedal (10) and controls the rotation speed of said electric motor (7) to obtain speed and acceleration performances of said vehicle which correspond to the heat engine (2) actual rpm and to the gear level selected on said gearbox simulator (11).

14) Control method of a series hybrid propulsion wheeled vehicle according to claim 13, wherein said control unit (4) furthermore limits the increase of rpm of said heat engine (2) within values corresponding to the progressive speeds actually developed by the vehicle under the impulse of said electric motor (7).

15) Control method of a series hybrid propulsion wheeled vehicle according to claim 13, wherein a coefficient of proportionality between the heat engine (2) operation and the gear level selected on said gearbox simulator (11) on the one hand, and the electric motor (7) operation on the other hand, is selectable from several different values.

16) Control method of a series hybrid propulsion wheeled vehicle according to claim 14 wherein, in said sports driving mode, starting and stopping of said heat engine (2) are operated manually by means of a mechanical or digital start/stop button (14).

17) Control method of a series hybrid propulsion wheeled vehicle according to claim 14 wherein, in said sports driving mode, the operation of said gearbox simulator (11) is carried out manually by means of levers (13) located close to a steering wheel (5) of said vehicle.
